(19) United States
(12) Patent Application Publication
(10) Pub. No.: US 2024/0386778 A1
(43) Pub. Date: Nov. 21, 2024

(54) CASINO PAYMENT SYSTEM AND METHOD WITH INTEROPERABILITY IN CASINO ENVIRONMENTS

(71) Applicant: Aristocrat Technologies, Inc., Las Vegas, NV (US)

(72) Inventors: Binh Nguyen, Reno, NV (US); Kristofor Jacobson, Las Vegas, NV (US); Charles Hiten, Boca Raton, FL (US)

(21) Appl. No.: 18/375,015

(22) Filed: Sep. 29, 2023

Related U.S. Application Data
(60) Provisional application No. 63/502,622, filed on May 16, 2023.

(51) Int. Cl. G07F 17/32; G06Q 20/04

(52) U.S. Cl. CPC G07F 17/3244; G06Q 20/0457

(57) ABSTRACT

A method of implementing TITO voucher exchanges between casinos for a player includes receiving a withdrawal request from the player to withdraw an amount of funds at a first casino, identifying a first player account having a first TITO voucher at the first casino, the first casino having a first TITO server, determining that the amount of the withdrawal request exceeds a balance of the first TITO voucher, identifying a second player account having a second TITO voucher at a second casino, the second casino having a second TITO server, selecting and redeeming the second TITO voucher using the second TITO server to generate proceeds, purchasing, using the first TITO server and the proceeds, a third TITO voucher, providing the third TITO voucher to the player, and recording in a central ledger, TITO transactions at the first TITO server and the second TITO server used to process the withdrawal request.

### CROSS-REFERENCE TO RELATED APPLICATIONS

This application claims priority to U.S. Provisional Patent Application No. 63/502,622, filed May 16, 2023 and titled “CASINO PAYMENT SYSTEM AND METHOD WITH INTEROPERABILITY IN CASINO ENVIRONMENTS”, which is hereby incorporated herein by reference in its entirety.

### TECHNICAL FIELD

The field of this disclosure relates generally to electronic gaming, and more specifically, to network-based systems and methods for seamlessly integrating different casino payments systems for players in a casino.

### BACKGROUND

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency, or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

Some known gaming devices may also use historical horse racing results (e.g., or other historical data) to determine wagering game outcomes. In some known systems, it may be desired and/or required for at least a portion of a historical event associated with the historical data to be displayed. Thus, according to some known systems, if a display device configured to display a historical event malfunctions or is otherwise inoperable, a gaming device associated with that display device may be required to shut down until that display device is fixed or replaced (e.g., because until the display device is fixed, the historical event(s) desired/required to be displayed as part of an electronic game will not be displayed). Accordingly, systems and methods are desired for dynamic monitor detection in electronic gaming such that if an initial display device becomes inoperable, data is automatically displayed on a different display device instead of requiring a shut down of the gaming device until the initial display device is fixed and/or replaced.

### BRIEF DESCRIPTION

In one aspect, a system configured to implement ticket in ticket out (TITO) voucher exchanges between a plurality of casinos for a player is provided. The system includes a central payments service implemented by at least one processor that is configured to execute programmed instructions which, when executed by the at least one processor, cause the at least one processor to receive a withdrawal request from the player to withdraw an amount of funds at a first casino of the plurality of casinos, identify a first player account of the player at the first casino, the first player account having at least one first TITO voucher, the first casino having a first TITO server, determine that the amount of the withdrawal request exceeds a balance of the at least one first TITO voucher, and identify a second player account of the player at a second casino of the plurality of casinos, the second player account having at least one second TITO voucher, the second casino having a second TITO server. The programmed instructions, when executed by the at least one processor, further cause the at least one processor to select and redeem, from the second player account using the second TITO server, the at least one second TITO voucher to generate proceeds for the withdrawal request, purchase, using the first TITO server and the proceeds, at least one third TITO voucher, provide the at least one third TITO voucher to the player, and record, in a central ledger, one or more TITO transactions at the first TITO server and the second TITO server used to process the withdrawal request for the player.

In another aspect, a method of implementing TITO voucher exchanges between a plurality of casinos for a player is provided. The method includes receiving, by a central payments service, a withdrawal request from the player to withdraw an amount of funds at a first casino of the plurality of casinos, identifying, by the central payments service, a first player account of the player at the first casino, the first player account having at least one first TITO voucher, the first casino having a first TITO server, determining, by the central payments service, that the amount of the withdrawal request exceeds a balance of the at least one first TITO voucher, and identifying, by the central payments service, a second player account of the player at a second casino of the plurality of casinos, the second player account having at least one second TITO voucher, the second casino having a second TITO server. The method further includes selecting and redeeming, by the central payments service from the second player account using the second TITO server, the at least one second TITO voucher to generate proceeds for the withdrawal request, purchasing, by the central payments service using the first TITO server and the proceeds, at least one third TITO voucher, providing, by the central payments service, the at least one third TITO voucher to the player, and recording, by the central payments service in a central ledger, one or more TITO transactions at the first TITO server and the second TITO server used to process the withdrawal request for the player.

In another aspect, a system configured to implement TITO voucher exchanges between a plurality of casinos for a player is provided. The system includes a central payments service implemented by at least one processor that is configured to execute programmed instructions which, when executed by the at least one processor, cause the at least one processor to receive a deposit request from the player to deposit an amount of funds, identify a location of the player, identify a casino of the plurality of casinos based on the location of the player, purchase, in the amount of the funds using a TITO server of the casino, at least one TITO voucher, provide the at least one TITO voucher to the player, and record, in a central ledger, one or more TITO transactions at the TITO server used to process the deposit request for the player.

### BRIEF DESCRIPTION OF THE DRAWINGS

FIG. 1 illustrates several different models of EGMs which maybe be networked to various gaming related servers in an example embodiment.

FIG. 2A is a block diagram depicting various functional elements of an EGM in an example embodiment.

FIG. 2B depicts a casino gaming environment in an example embodiment.

FIG. 2C is a diagram of components of a system for providing online gaming in an example embodiment.

FIG. 3 illustrates, in block diagram form, an implementation of a game processing architecture algorithm that implements a game processing pipeline for the play of a game in accordance with various implementations described herein.

FIG. 4 illustrates an overview of some of the components and services of a system that provides interoperability between different casino payment systems in an example embodiment.

FIG. 5 is a block diagram of a universal slot machine interface board in an example embodiment.

FIG. 6 depicts a process for a player at an electronic game machine or table in an example embodiment.

FIGS. 7-10 depict additional details of the process of FIG. 6 in example embodiments.

FIG. 11 depicts a process for a player using a mobile game device in an example embodiment.

FIGS. 12-15 depict additional details of the process of FIG. 11 in example embodiments.

FIG. 16 depicts a flow chart of a method of mediating CMS communications between a plurality of incompatible CMS payment systems and a plurality of gaming devices of at least one gaming venue in an example embodiment.

### DETAILED DESCRIPTION

Casino payments systems are generally fragmented, with each manufacturer implementing different proprietary protocols and proprietary payments systems for casino transactions that do not communicate with each other. Some examples of casino payment systems include ticket-in-ticket-out (TITO) servers, account-based systems, mobile cashless, etc. Once a casino chooses one of the available proprietary systems from a manufacturer, they stay with it. Because each casino may utilize a different payment system, a player needs to open an account at each casino. Therefore, credits/debits from a user account cannot be freely transferred between casinos due to the user of incompatible payment systems. Accordingly, it is desirable to have a centralized payment processing system that can allow players to be able to exchange credits/debits from one casino account to another casino account. Regardless of which casino a player is at, the player should be able to exchange their available monetary credits (e.g., US dollars) for credits at another gaming location. However, these types of transactions should be done in a way that casinos are not required to store the players money, which may require a casino to become a bank and be regulated as a bank (e.g., requiring casinos to hold reserves, provide deposit insurance, be subjected to compliance checks and audits as a bank would, etc.).

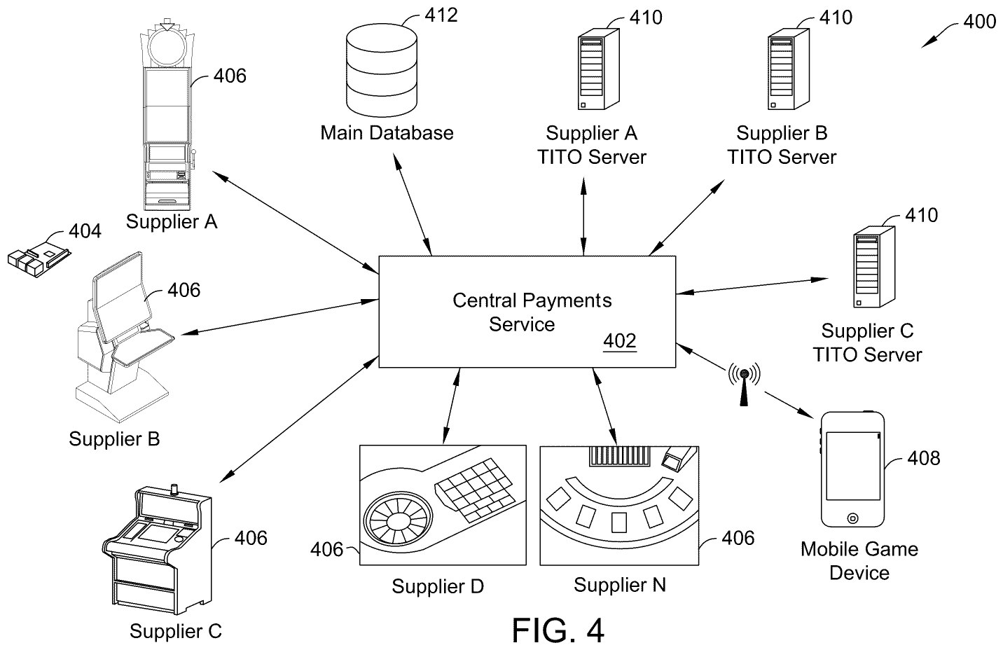

In the embodiments described herein, a central payments system (or a central payments service) (CPS) is described that monitors financial transactions across multiple gaming venues, and the CPS keeps an aggregate financial balance of each player across multiple gaming properties where the players have accounts, in a central ledger (CL). The specific details of the CPS will be described in more detail with respect to FIG. 4.

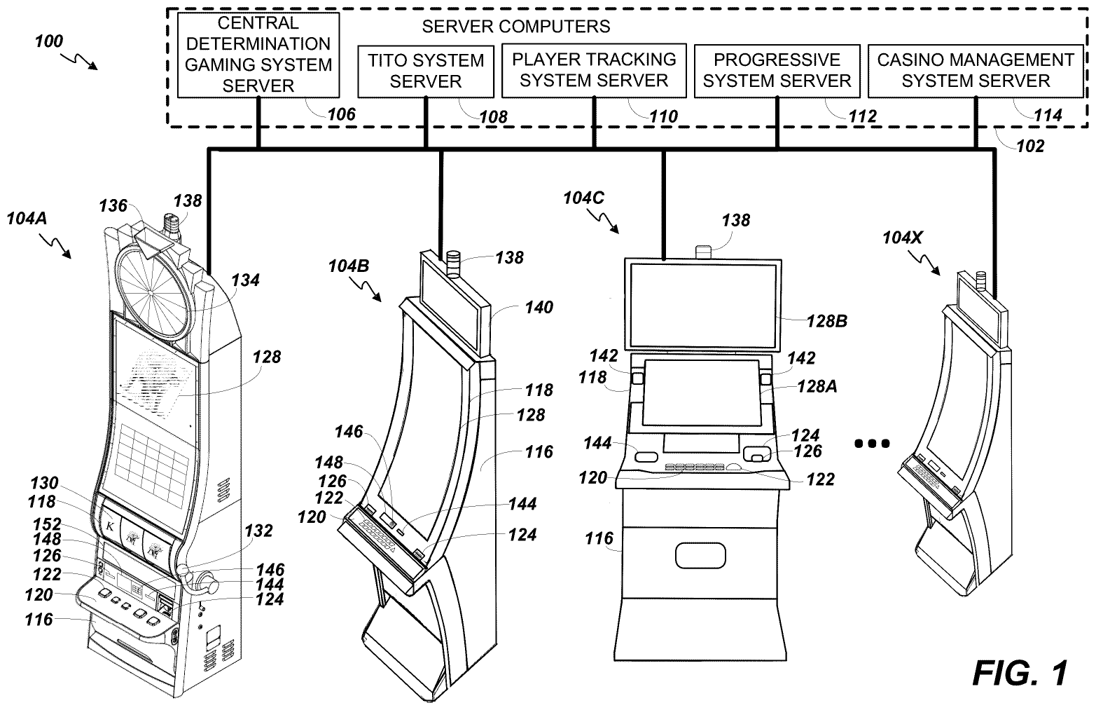

FIG. 1 illustrates several different models of EGMs which may be networked to various gaming related servers in an example embodiment. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

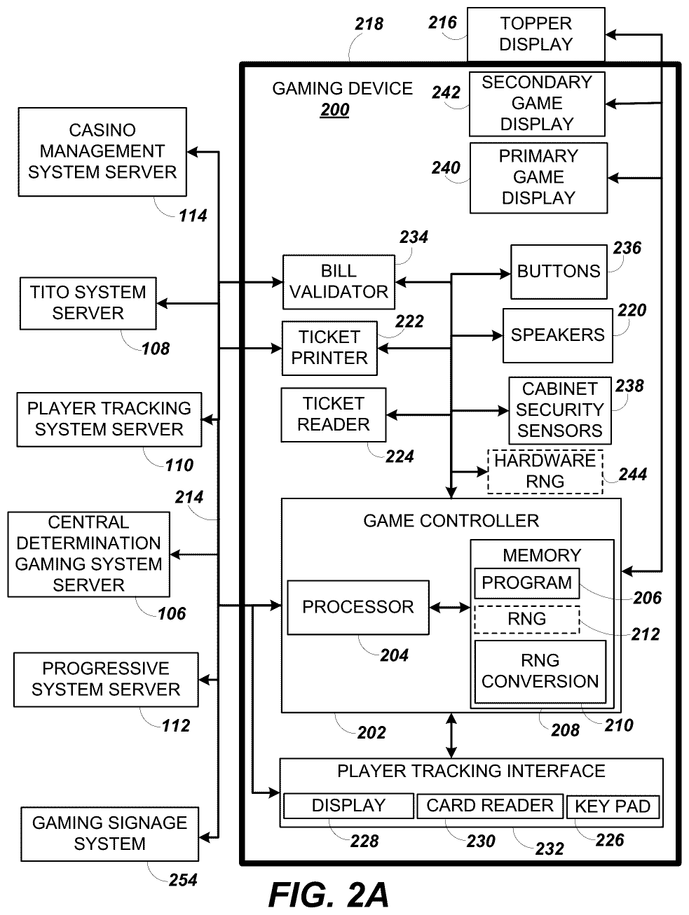

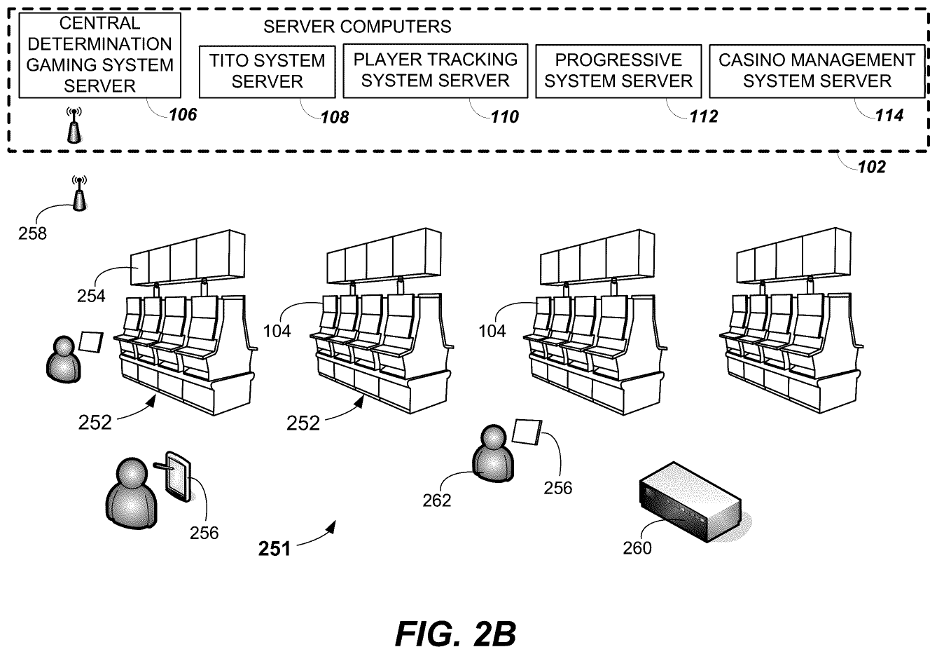

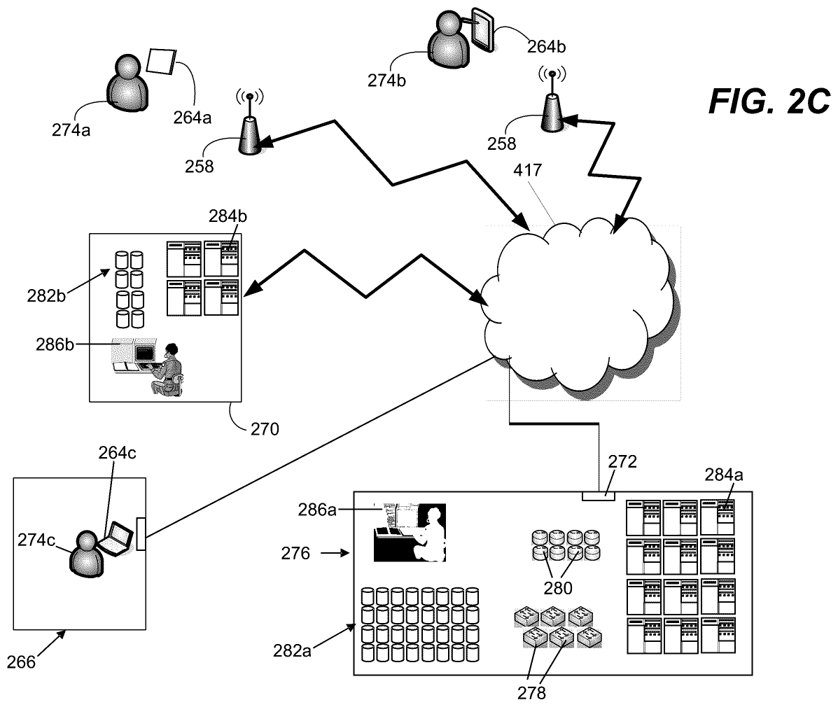

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting various functional elements of a gaming device 200 (e.g., an EGM) in an example embodiment. All or parts of gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204: (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games: newly introduced game elements such as extra reels, new symbols, or new cards: stop positions for dynamic game elements such as spinning reels, spinning wheels, or shifting reels: or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The player uses the credit balance to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment in an example embodiment. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram of components of a system for providing online gaming in an example embodiment. As with other figures presented in this disclosure, the numbers, types, and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

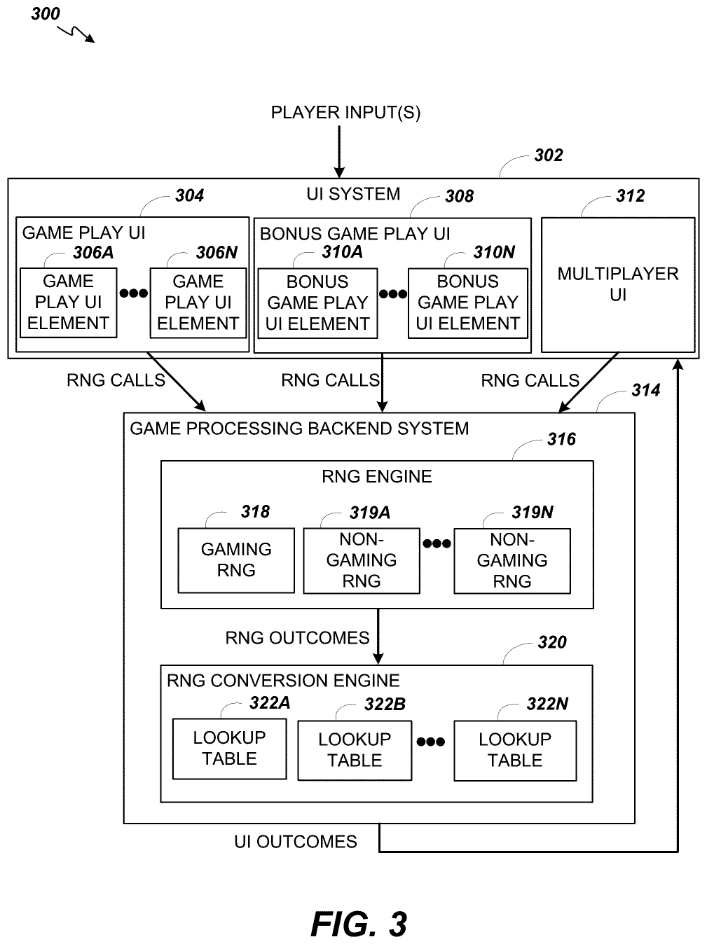

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

FIG. 4 illustrates an overview of some of the components and services of a system 400 that provides interoperability between different casino payment systems in an example embodiment. Any of the components of system 400 may be performed, for example, by server computers 102 of FIG. 1. In this embodiment, system 400 includes a central payments service 402, a universal SMIB (uSMIB) 404, electronic game machines and/or tables (EGM/Ts) 406, mobile game devices 408, TITO servers 410, and a database 412.

Central payments service 402 may be implemented as a local server, in the cloud, or by combinations thereof. Central payments service 402 is configured to monitor financial transactions across multiple gaming venues, and central payments service 402 may keep an aggregate financial balance of each player across multiple gaming properties where they have accounts. This information may be held in a central ledger stored in database 412, represented as monetary credits, promotional credits, cryptographic currency, non-fungible tokens (NFTs), virtual goods, loyalty points, TITO vouchers, and the like. A player's aggregate credit balance may be stored as monetary credits only, loyalty points only, cryptographic currency only, NFTs only, promotional credits only, virtual goods, TITO credits only, or a mixture of all. For example, to store the aggregate credit balance as only monetary credits, any TITO voucher deposited by the player needs to be redeemed for credits at the local venue that issued the TITO voucher, and then added to the player's account balance at that venue. This updated local venue balance is sent to central payments service 402 to update the cross-property aggregate credit balance for the player. Central payments service 402, generally, coordinates and records TITO voucher buy or sell transactions in order to satisfy a player's money-in (deposit), and/or money-out (withdrawal), and/or transfer requests. Generally, transfer requests may include the transfer of funds or credits from a gaming account to a gaming device, from a gaming device back to the gaming account, a transfer from one gaming account to another gaming account, a transfer from/to a gaming account to/from a bank account, etc.

Central payments service 402, in order to process a credit withdrawal for a player, may receive a player's request for funds, detect a player's location (e.g., detect the player's proximity to beacons or uSMIBs 404), determine which TITO system is used at that location, look up the central ledger for the player's accounts, select a few TITO vouchers and/or credits available from any other venues that will add up to the least amount of credits requested, exchange the selected TITO vouchers and/or credits for the requested fund amount to a TITO voucher-type used by the casino where the player is at, send the new TITO voucher to the player (e.g., at EGM/Ts 406, mobile game devices 408, etc.), and record the transaction (e.g., sell TITO vouchers A, B, C at casino X, Y, Z, and buy TITO vouchers at the casino where the player is located). If there are leftover funds, central payments service 402 may, as needed, exchange the leftover funds at another TITO system, or keep it as credit, and deposit it back into one of the venues where the player maintains an account. The player's aggregate account is updated accordingly. In general, this process, or a similar process, may be used with other similar valuable components such as loyalty points, cryptographic currency, NFTs, virtual goods, and the like.

In some embodiments, uSMIBs 404 are remotely configured to function as central payments service 402 to receive the fund transfer data, interpret the context, and route the fund transfer request to its prescribed destination. In this embodiment, central payments service 402 is embedded in the uSMIB, and the network may utilize a peer-to-peer network as each node (uSMIB) routes a request to the proper destination. The result is that central payments service 402 becomes, in essence, a distributed payment service (e.g., not centralized) with its own exchange systems for the different value instruments.

In some embodiments, uSMIBs 404 are remotely configured by central payments service 402 to receive the fund transfer data wirelessly (e.g., via a Wi-Fi or a cellular network) directly from the central payments service 402, interpret the context, and execute the commands (e.g., credit the player's EGM/T 406 with $100 TITO voucher based on a remote deposit command). Conversely, the player may withdraw funds from EGM/Ts 406 wirelessly and deposit their credits back to their account at the same and/or a different casino where a conversion of the value instrument in the transaction may or may not be required. All transactions may be posted at the central payments service 402 in order to update the player's aggregate balance. In some embodiments, uSMIBs 404 are capable of both wired and wireless communications in order to receive funding inputs from a card reader, a bill acceptor (e.g., at EGM/Ts 406), a TITO voucher, an electronic-check, an electronic fund transfer, virtual goods, and/or any value instrument directly from mobile game device 408. In some embodiments, uSMIBs 404 sit between managed devices (e.g., EGM/Ts 406) and central payments service 402, facilitating the “last mile” communication between a server implementing central payments service 402 and the managed device (e.g., EGM/Ts 406).

In some embodiments, central payments service 402 configures a local database of uSMIBs 404 (e.g., configures what protocol to speak with EGM/Ts 406, what protocols to use with the backend servers (e.g., TITO servers 410, player tracking servers, eWallet server, progressive servers, etc., at the casino that the player is located at)). In some embodiments, central payments service 402 configures the routing tables for uSMIBs 404, which may define which nodes should be used to forward transaction messages to central payments service 402. In some embodiments, payment methods are communicated directly to uSMIBs 404 from EGM/Ts 406, from a bill acceptor, a card reader, a wireless communication port (e.g., a mobile device interface that provides digital TITO voucher data, a barcode, etc.). In some embodiments, uSMIBs 404 are configured to recognize various payment methods (e.g., paper TITO vouchers, virtual/digital TITO vouchers, player account credit/debit commands from a mobile device, credit card, debit card, cash, cryptographic currency, NFTs, loyalty points, virtual goods, etc.) transmitted either directly or from a card reader, a mobile wireless interface, and/or a bill acceptor, to uSMIBs 404, or indirectly from a CPU board of EGM/Ts 406.

In this embodiment, central payments service 402 aggregates a player's account balance from multiple casino locations, buys/sells TITO vouchers and other value instruments as needed to complete a player's fund transfer request while the player is at a particular location. Central payments service 402 may include or communicate with a location system that detects a player's location at a particular gaming location when a player starts a transaction. This data is sent by the location system and stored by central payments service 402. Location data may be used to verify that a player is in a location that allows gaming transactions and generate a record that the transaction did take place at that particular location and time in case of a dispute, compliance audit, etc. As discussed previously, the central ledger (which may be stored at database 412) stores each player's aggregate balance across multiple casinos. Central payments service 402 operates to aggregate and reconcile credits/debit transactions continuously to arrive at a real-time balance, regardless of which casino a player is currently at. Central payments service 402 may store, for example, at database 412, historical transaction data, plus device-specific configuration data. Central payments service 402 may store transactions for audit purposes, profiles of EGM/Ts 406, TITO server 410 transactions, other value instruments as described herein, and may implement various back-end systems such as progressive servers, bonus servers, marketing servers, casino data servers, player tracking servers, financial servers, loyalty servers, cryptographic servers, NFT servers, virtual good servers, etc.). Central payments service 402 may store lookup tables or mapping tables for translating commands and requests from incompatible systems, value instruments, and devices, and/or may store regulations of the various gaming jurisdictions that may affect how transactions, such as value instrument exchanges and marketplaces, are implemented.

In some embodiments, central payments service 402 implements remote discovery and configuration of uSMIBs 404 based on their locations. For example, central payments service 402 may configure each of uSMIBs 404 based on their jurisdictional location requirements, based on their operating requirements on the casino floor, based on their requirements on recognizing various user fund transfer inputs (e.g., suspicious transactions relating to money laundering), to enable them to construct a transaction message to a particular TITO system, to enable them to communicate with central payments service 402 on transaction states, etc. Central payments service 402 tracks a player's digital wallet via monetary credit and/or TITO vouchers, and/or value instruments and the like, which are a claim to the ownership of a monetary amount. That is, for example, the TITO barcodes and the credits represent a right to an amount of money, but do not represent the physical or digital money itself. A casino storing credits and/or a number of TITO barcodes do not store actual money, only the rights to an amount of money. Therefore, casinos avoid being regulated as a bank because it is a ledger and not a depository institution.

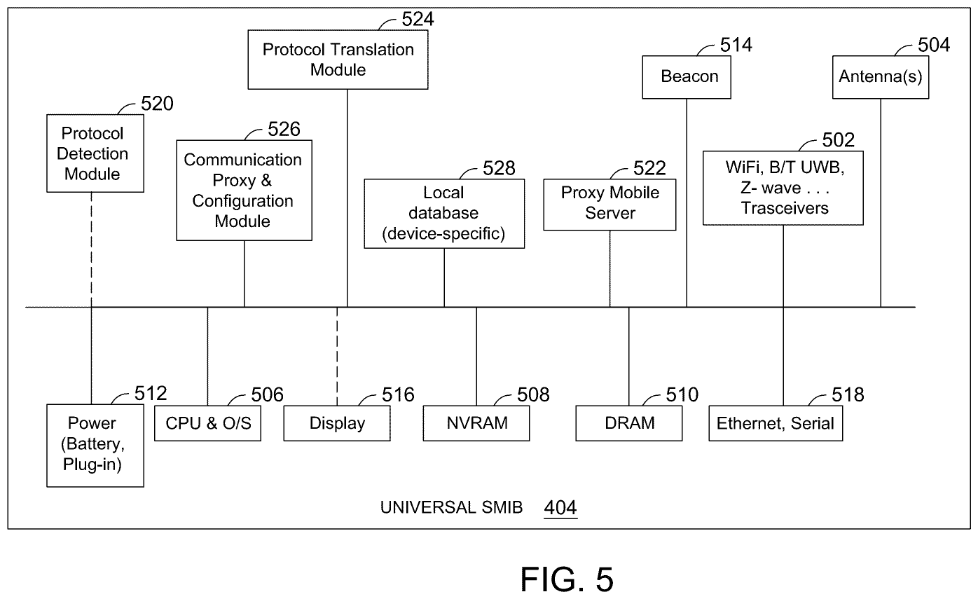

FIG. 5 is a block diagram of uSMIB 404 in an example embodiment. uSMIB 404 includes any component, system, or device that performs the functionality described herein for the uSMIBs as described herein. uSMIB 404 will be described with respect to various discrete elements, which perform functions. These elements may be combined in different embodiments or segmented into different discrete elements in other embodiments.

In some embodiments, uSMIB 404 includes one or more wireless transceivers 502 communicatively coupled to one or more antennas 504. Wireless transceivers 502 may implement any wireless network as desired, using any network topology and protocol, including Wi-Fi networks, Bluetooth networks, Z-wave networks, Zigbee networks, Ultra-Wide Band networks, cellular networks, etc.

In this embodiment, uSMIB 404 includes at least one processor 506, and a non-volatile random-access memory 508 (NVRAM). NVRAM 508 may include, for example, solid-state disks (SSD), ferroelectric RAM (FeRAM), magneto resistive RAM (MRAM), etc. In this embodiment, uSMIB 404 further includes dynamic RAM (DRAM) 510. In this embodiment, uSMIB 404 also includes a power module 512. Power module 512 may include batteries, which provide mobile operation for uSMIB 404 without, and/or in addition to (e.g., backup power), using a wired power connection to uSMIB 404. In other embodiments, power module 512 includes a fixed or removable power connection to external power, resulting in uSMIB 404 being hard-wired to a power source. In some embodiments, uSMIB 404 may include one or more of a beacon 514, a display 516, Ethernet/Serial interfaces 518 (e.g., Ethernet, serial bus (e.g., universal serial bus (USB), RS-232, RS-485 interfaces), etc.), an EGM/T protocol detection module 520, and a proxy mobile server 522 for direction communication with mobile devices of users (not shown).

Beacon 514 may, for example, comprise a Bluetooth low-energy (BLE) beacon, or any RF beacon, which interacts with mobile devices of users (not shown) to enable central payments service 402 to provide identification and location-based services to the mobile devices. Display 516 may be used to display information, such as the status of uSMIB 404, player credit balances, TITO voucher information, etc. Ethernet/Serial interfaces 518 may be used, in combination with or instead of wireless transceivers 502, to enable uSMIB 404 to communicate with central payments service 402 and/or TITO servers 410. EGM/T protocol detection module 520 may be used to allow uSMIB 404 to automatically identify the local communication protocols used by EGM/Ts 406. Proxy mobile server 522 may be used to allow uSMIB 404 to communicate directly with a user's mobile device to, for example, add money to EGM/Ts 406 and/or a player's account.

In this embodiment, uSMIB 404 includes a protocol translation module 524, which allows uSMIB 404 to communicate with, at least, EGM/Ts 406 and TITO servers 410. Communication proxy & configuration module 526 interacts with database 412 to communicate and to retrieve configuration information and device profiles for EGM/Ts 406, along with device profiles for TITO servers 410. Although not shown in FIG. 5, uSMIB 404 may include central payments service 402 (e.g., as a component of protocol translation module 524 or as a standalone module on uSMIB 404) in embodiments where uSMIB 404 operates in a stand-alone configuration, when central payments service 402 is not configured external to uSMIB 404. As discussed previously, uSMIB 404 may be virtualized to operate as a virtual machine, a software module, or combinations thereof. In some embodiments, uSMIB 404 includes a local database 528, which stores device-specific information which may be used, for example, to configure an EGM/T 406 that uSMIB 404 is attached to.

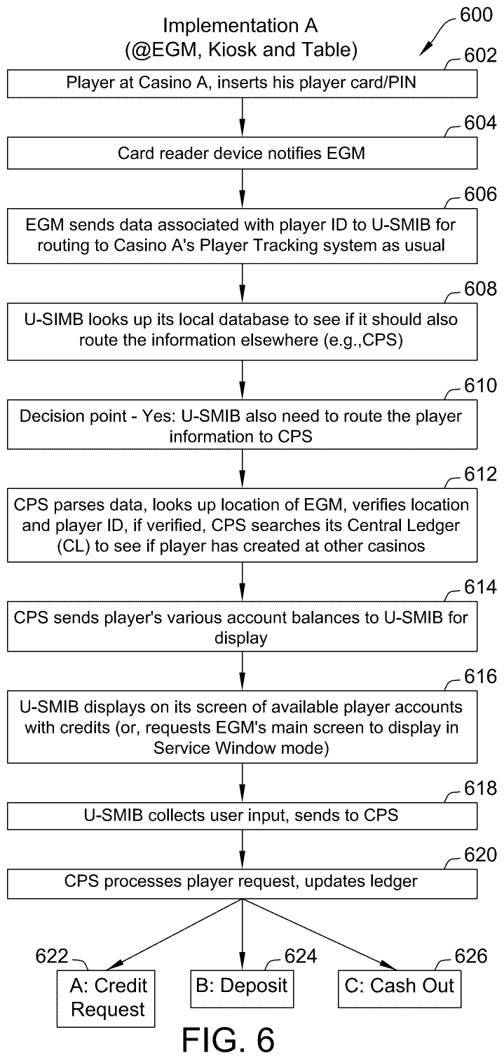

FIG. 6 depicts a process 600 for a player at EGM/T 406 in an example embodiment. Although the embodiments discussed below uses TITO voucher(s) as an exemplified value instrument, the processes for requesting credits, or depositing credits, or cashing out, of a gaming device is essentially the same for other value instruments such as cryptographic currencies, NFTs, loyalty points, virtual goods, and the like. Note that some value instruments require the sell or buy of value instruments owned, chosen, selected, borrowed, etc., by the user (e.g., virtual goods, NFTs, cryptographic currencies, and the like) on an Exchange or a Marketplace appropriate for the value instrument involved in the transaction in exchange for gaming credits at a given time and/or location.

Process 600 begins when a player at casino A inserts his/her player card/PIN at EGM/T 406 (see step 602). The card reader device notifies EGM/T 406 that the player has inserted his/her player card (see step 604). EGM/T 406 sends data associated with the player ID to uSMIB 404 associated with the player's EGM/T 406 to casino A's player tracking system (see step 606). uSMIB 404 may then query its local database 528 to determine if it should also route the information elsewhere (e.g., to central payments service 402, see step 608). If uSMIB 404 decides that the information should be routed to central payments service 402, then uSMIB 404 routes the information to central payments service 402 (see step 610). Central payments service 402 parses the data, determines the location of EGM/T 406, and verifies the location and the player ID. If the location and the player ID are verified, central payments service 402 searches the central ledger to determine if the player has credits at other casinos (see step 612). Central payments service 402 may then send the player's various account balances to uSMIB 404 for display to the player (see step 614). uSMIB 404 generates and causes to be displayed on display 516 (see FIG. 5) the available player accounts with credits, and/or requests that a display at EGM/T 406 provides this information (see step 616). uSMIB 404 may then receive input from the player selecting one or more of the available player accounts, and uSMIB 404 sends the selections to central payments service 402 (see step 618). Central payments service 402 may then processes the player's request and update its central ledger (see step 620). In this embodiment, the request may include a credit request (see step 622), a deposit request (see step 624), and a cash out request (see step 626).

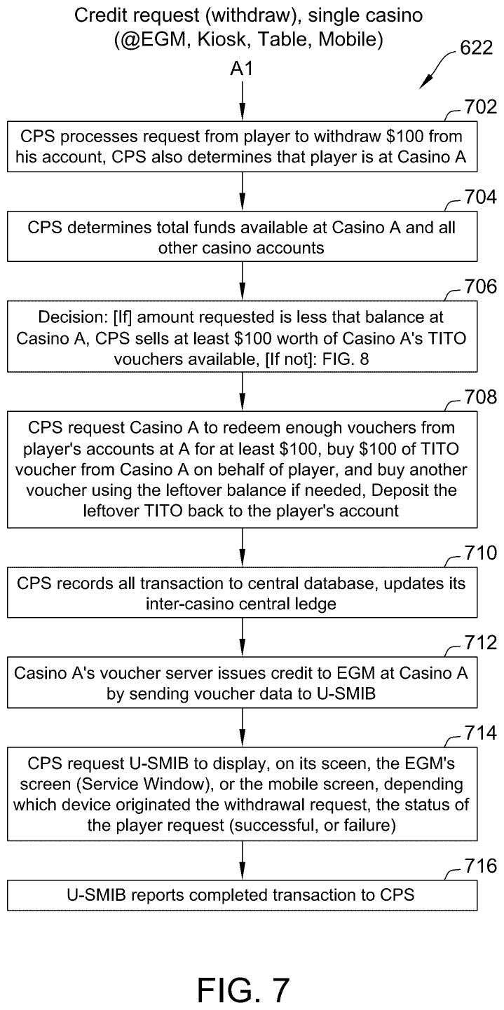

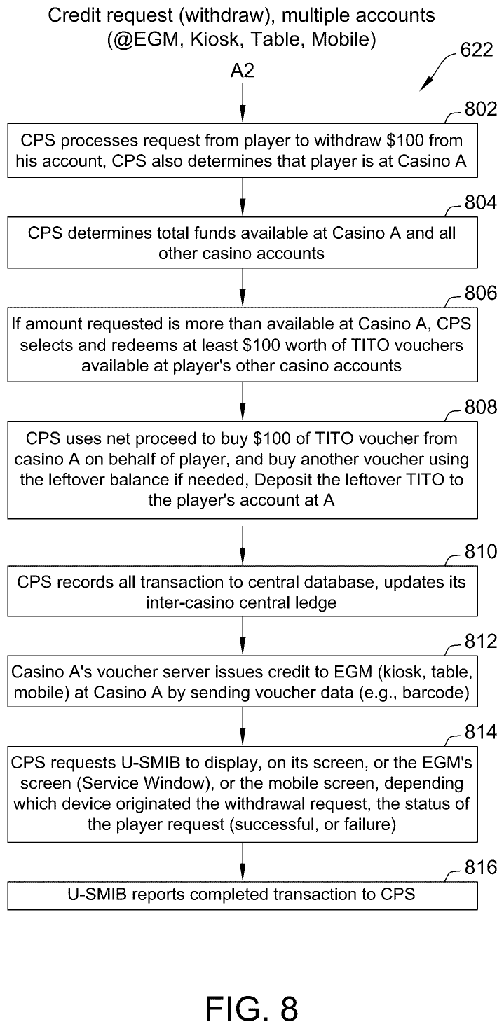

FIG. 7 depicts additional details of the credit request (see step 622 of FIG. 6) for a single casino account in an example embodiment. In order to process a credit request for a single casino account, central payments service 402 processes the request from the player to withdraw (e.g., $100) from the player's account. Central payments service 402 also determines that the player is at casino A (see step 702). Central payments service 402 may then determine the total funds available at casino A, and may determine the total funds available at all other casino accounts (see step 704). Central payments service 402 determines if the amount requested is less than the balance at casino A. If the amount requested is less than the balance at casino A, then central payments service 402 sells at least the requested amount (e.g., $100) worth of casino A's TITO vouchers that are available. If the amount requested is more than the balance at casino A, then central payments service 402 operates to collate TITO vouchers from multiple accounts (see step 706). The use of multiple accounts to service the credit request will be discussed with respect to FIG. 8. Central payments service 402 may then request that casino A redeem enough TITO vouchers from the player's account for at least the requested amount, and central payments service 402 may then buy the requested amount of TITO vouchers from casino A on behalf of the player. Central payments service 402 may buy another TITO voucher using the leftover balance, if needed, and deposit the leftover TITO voucher back into the player's account (see step 708). Central payments service 402 may then record the transactions regarding the player's request in database 412, and updates its central ledger (see step 710). Casino A's TITO server 410 issues a credit to the EGM/T 406 at casino A by sending TITO voucher data to its uSMIB 404 (see step 712). Central payments service 402 may then request that uSMIB 404 display the status of the player request (see step 714), and uSMIB 404 may then report the completed transaction to central payments service 402 (see step 716).

FIG. 8 depicts additional details of the credit request (see step 622 of FIG. 6) for multiple casino accounts in an example embodiment. In order to process the credit request that utilize multiple casino accounts, when the credit request from the player exceeds the amount at casino A, central payments service 402 processes the request from the player to withdrawn from the player's account the requested amount of $100. Central payments service 402 also determines that the player is at casino A (see step 802). Central payments service 402 determines the total funds available at casino A, and the funds at other casino accounts (see step 804). If the amount requested $100 is more than the available credit at casino A, then central payments service 402 selects and redeems at least the $100 worth of TITO vouchers available at the player's other casino accounts (see step 806). Central payments service 402 uses the net proceeds to buy the $100 in TITO vouchers from casino A on behalf of the player, and central payments service 402 may buy another TITO voucher using the leftover balance if needed. Central payments service 402 may then deposit the leftover TITO voucher to the player's account at casino A (see step 808). Central payments service 402 may then record the transactions to database 412, and update its central ledger (see step 810). Casino A's TITO server 410 issues a TITO voucher to EGM/T 406 by sending TITO voucher data (e.g., a barcode, see step 812). Central payments service 402 may then request that uSMIB 404 display the status of the player's request (e.g., success or fail, see step 814), and uSMIB 404 may then report the completed transaction to central payments service 402 (see step 816).

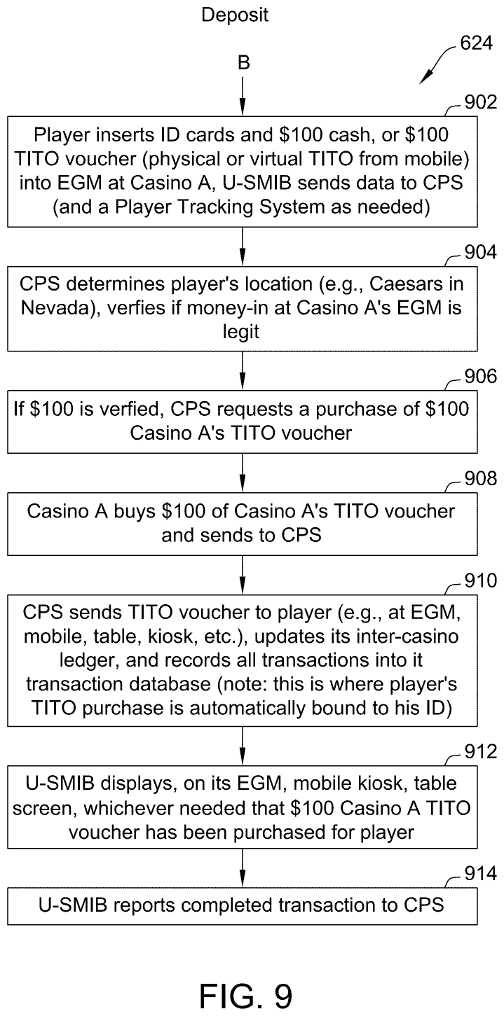

FIG. 9 depicts additional details of the deposit request (see step 624 of FIG. 6) in an example embodiment. In order for the player to make a deposit into an account (e.g., $100), the player inserts their ID card and cash or a TITO voucher (e.g., a physical TITO voucher or from a mobile) into EGM/T 406 at casino A. uSMIB 404 sends the data to central payments service 402 (and to a player tracking system, if needed, see step 902). Central payments service 402 determines the player's location, and verifies if the deposit at casino A is legitimate (see step 904). If the deposit is legitimate, then central payments service 402 requests a purchase of $100 in a casino A's TITO vouchers (see step 906). Casino A buys $100 of casino A's TITO vouchers and sends it to central payments service 402 (see step 908). Central payments service 402 sends the TITO voucher to the player (e.g., at EGM/T 406, mobile game device 408, etc.), and central payments service 402 updates its central ledger. Central payments service 402 also records the transactions in database 412 (see step 910), and uSMIB 404 may display (e.g., on EGM/T 406) that the $100 casino A's TITO voucher has been purchased for the player (see step 912). uSMIB 404 may then report the completed transaction to central payments service 402 (see step 914).

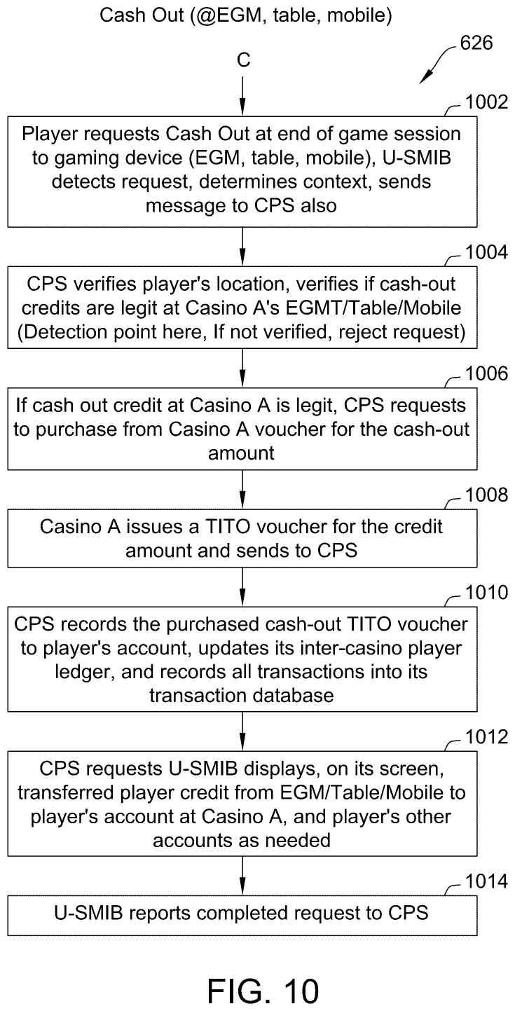

FIG. 10 depicts additional details of the cash out request (see step 626 of FIG. 6) in an example embodiment. In order to process the cash out request, the player requests a cash out at the end of a gaming session from EGM/T 406. uSMIB 404 of EGM/T 406 detects the request, determines the context, and sends a message to central payments service 402 (see step 1002). Central payments service 402 verifies the player's location and verifies if the cash out credits are legitimate at casino A's EGM/T 406. If this information is not verified, the request is rejected (see step 1004). If the cash out credit at casino A is legitimate, then central payments service 402 requests to purchase from casino A's TITO server 410, a TITO voucher for the cash out amount (see step 1006). Casino A's TITO server 410 issues a TITO voucher for the credit amount and sends it to central payments service 402 (see step 1008). Central payments service 402 records the purchased cash out TITO voucher to the player's account, updates its central ledger, and records the transactions in database 412 (see step 1010). Central payments service 402 may then request that uSMIB 404 of EGM/T 406 displays the transferred player credit from EGM/T 406 to the player's casino A account, and/or other accounts as needed (see step 1012). uSMIB 404 may then report the completed request to central payments service 402 (see step 1014).

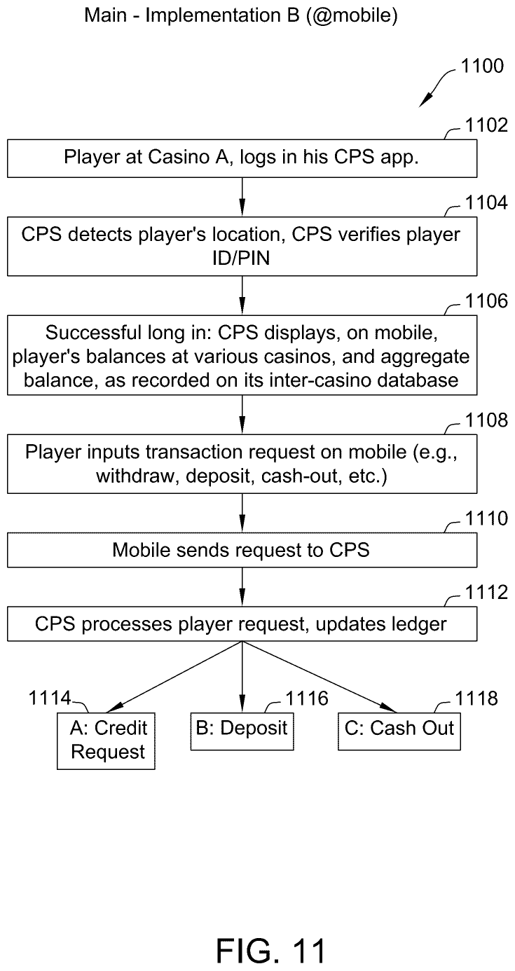

FIG. 11 depicts a process 1100 for a player using mobile game device 408 in an example embodiment. A player at casino A logs into a mobile application (see step 1102), and central payments service 402 detects the player's location and verifies the player's ID or PIN (see step 1104). If the logon is successful, central payments service 402 displays on mobile game device 408, the player's balances at various casinos, and aggregate balance, as recorded on its central ledger (see step 1106). The player may then input a transaction request on mobile game device 408 (see step 1108), and mobile game device 408 sends the request to central payments service 402 (see step 1110). Central payments service 402 processes the player's request, and updates its central ledger (see step 1112). In this embodiment, the request may include a credit request (see step 1114), a deposit request (see step 1116), and a cash out request (see step 1118).

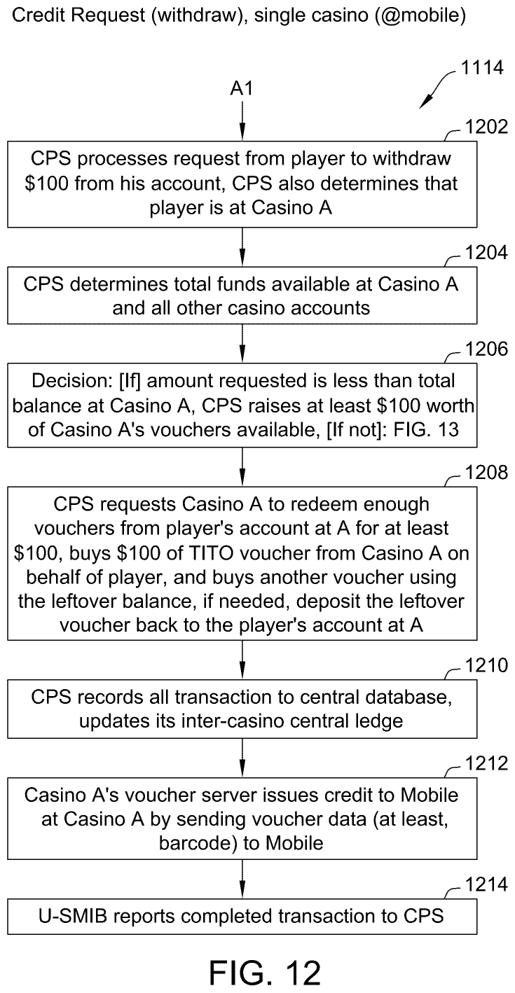

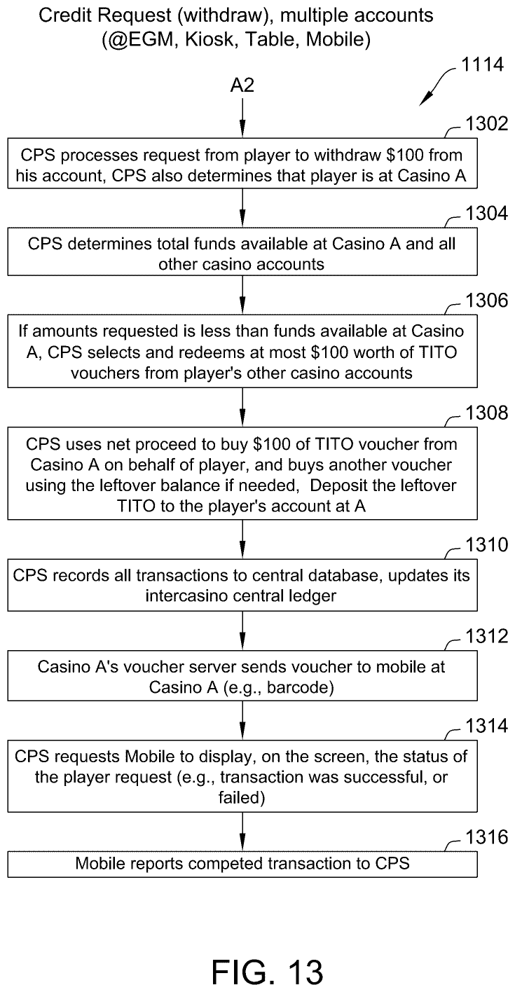

FIG. 12 depicts additional details of the credit request (see step 1114 of FIG. 11) for a single casino account in an example embodiment. In order to process a credit request for a single casino account, central payments service 402 processes the request from the player to withdraw (e.g., $100) from the player's account. Central payments service 402 also determines that the player is at casino A (see step 1202). Central payments service 402 determines the total funds available at casino A, and the funs at other casino accounts (see step 1204). Central payments service 402 may then determine if the amount requested is less than the balance at casino A. If the amount requested is less than the balance at casino A, then central payments service 402 sells at least the requested amount (e.g., $100) worth of casino A's TITO vouchers that are available. If the amount requested is more than the balance at casino A, then central payments service 402 operates to collate TITO vouchers from multiple accounts (see step 1206). The use of multiple accounts to service the request will be discussed with respect to FIG. 13. Central payments service 402 requests that casino A redeem enough TITO vouchers from the player's account with casino A for at least the requested amount, and buys the requested amount of TITO vouchers from casino A on behalf of the player. Central payments service 402 may then buy another TITO voucher using the leftover balance if needed, and deposit the leftover TITO voucher back into the player's account (see step 1208). Central payments service 402 may then record the transactions regarding the player's request in database 412, and update its central ledger (see step 1210). Casino A's TITO server 410 issues credit to the mobile game device 408 at casino A by sending TITO voucher data to its mobile game device 408 (see step 1212). Mobile game device 408 may then report the completed transaction to central payments service 402 (see step 1214).

FIG. 13 depicts additional details of the credit request (see step 1114 of FIG. 11) for multiple casino accounts in an example embodiment. In order to process the credit request using multiple casino accounts, when the credit request exceeds the amount at casino A, central payments service 402 processes the request from the player to withdrawn from the player's account $100. Central payments service 402 also determines that the player is at casino A (see step 1302). Central payments service 402 determines the total funds available at casino A, and other casino accounts (see step 1304). If the amount requested (e.g., $100) is more than the credit available at casino A, then central payments service 402 selects and redeems at least the $100 worth of TITO vouchers available at the player's other casino accounts (see step 1306). Central payments service 402 may then use the net proceeds to buy the $100 in TITO vouchers from casino A on behalf of the player, and may buy another TITO voucher using the leftover balance, if needed. Central payments service 402 may then deposit the leftover TITO voucher into the player's account at casino A (see step 1308). Central payments service 402 records transactions to database 412, and updates its central ledger (see step 1310). Casino A's TITO server 410 issues a TITO voucher to mobile game device 408 by sending TITO voucher data to mobile game device 408 (e.g., a barcode, see step 1312). Central payments service 402 requests that mobile game device 408 display the status of the player's request (see step 1314), and mobile game device 408 may then report the completed transaction to central payments service 402 (see step 1316).

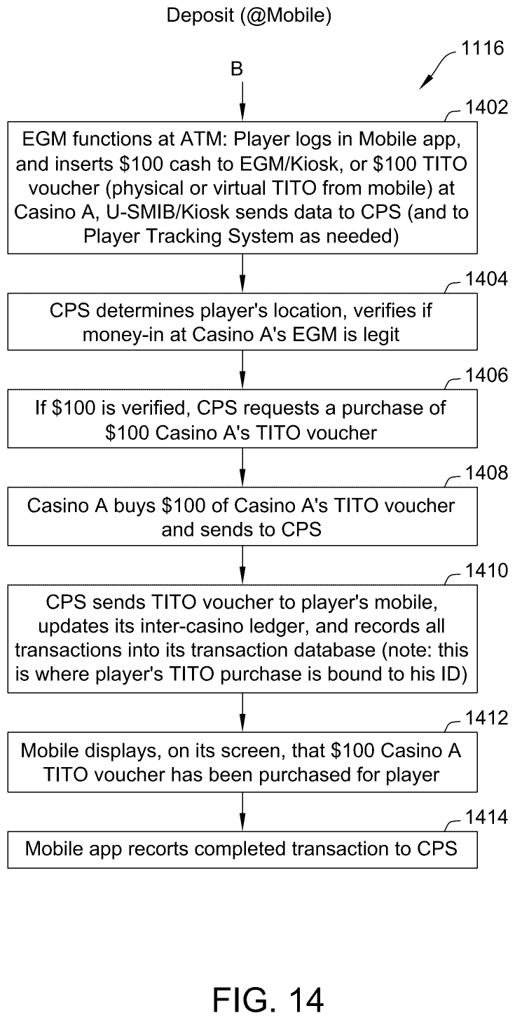

FIG. 14 depicts additional details of the deposit request (see step 1116 of FIG. 11) in an example embodiment. In order for the player to make a deposit into an account (e.g., $100), the player logs into the mobile application, and inserts $100 cash into EGM/T 406 or a kiosk, or inserts or scans a $100 TITO voucher (physical or virtual) at casino A. uSMIB 404 sends data to central payments service 402 (and to a player tracking system, if needed, see step 1402). Central payments service 402 determines the player's location, and verifies if the deposit at casino A is legitimate (see step 1404). If the deposit is legitimate, then central payments service 402 requests a purchase of $100 in a casino A's TITO vouchers (see step 1406). Casino A buys $100 of casino A's TITO vouchers, and sends it to central payments service 402 (see step 1408). Central payments service 402 sends the TITO voucher to the player's mobile game device 408, and central payments service 402 updates its central ledger. Central payments service 402 may also record the transactions in database 412 (see step 1410). Mobile game device 408 displays on its screen, that the $100 casino A's TITO voucher has been purchased for the player (see step 1412). Mobile game device 408 may then report the completed transaction to central payments service 402 (see step 1414).

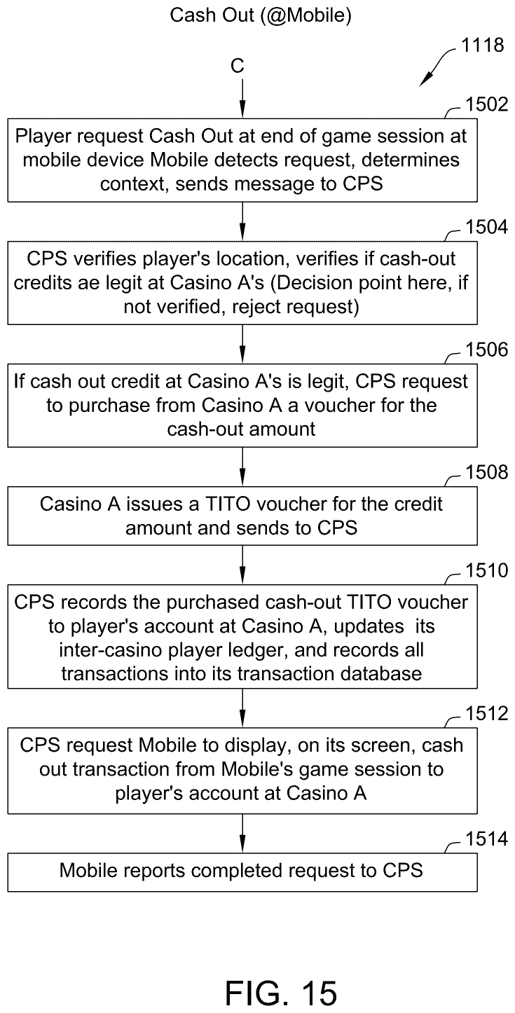

FIG. 15 depicts additional details of the cash out request (see step 1118 of FIG. 11) in an example embodiment. In order to process the cash out request, the player requests a cash out at the end of a gaming session at mobile game device 408. Mobile game device 408 detects the request, determines the context, and sends a message to central payments service 402 (see step 1502). Central payments service 402 verifies the player's location and verifies if the cash out credits are legitimate at casino A's gaming device. If not verified, the request is rejected (see step 1504). If the cash out credit at casino A is legitimate, central payments service 402 requests to purchase from casino A, a TITO voucher for the cash out amount (see step 1506). Casino A issues a TITO voucher for the credit amount and sends it to central payments service 402 (see step 1508). Central payments service 402 records the purchased cash out TITO voucher to the player's account, updates its central ledger, and records the transactions in database 412 (see step 1510). Central payments service 402 may then request that mobile game device 408 display the cash out transaction to the player's account at casino A (see step 1512), and mobile game device 408 may then report the completed request to central payments service 402 (see step 1514).

In some embodiments, rather than linking all of the TITO vouchers across the different casinos using a player's aggregate account, the different TITO tickets distributed across multiple casinos can be linked to a single master TITO ticket that has a single aggregated value. In these embodiments, central payments service 402 generates a single master TITO ticket which would link to the multiple TITO vouchers distributed at multiple gaming venues. When a player attempts to fund a gaming session with the single master TITO ticket at a local gaming venue, central payments service 402, using the central ledger, selects vouchers from the current gaming venue and/or other gaming venues for redemption according to the funding request value. Central payments service 402 sends instructions to the current gaming venue to purchase a TITO voucher accepted by the gaming venue. After purchasing the new TITO voucher, central payments service 402 sends the new TITO voucher information to EGM/T 406 and/or mobile game device 408 to fund the current gaming session.

In order to avoid having the TITO vouchers become classified as unredeemed or expired TITO vouchers, central payments service 402 may initiate a redemption of the existing TITO voucher and purchase a new TITO voucher. In some cases, if the player decides to end his or her game play for a prolonged period of time (e.g., a vacation for the player has ended), the player may implement a final cash out of the aggregated account balance recorded in the central ledger. During the final cash out process, central payments service 402 redeems the TITO vouchers held at the local gaming venue and transfers them to an external account.

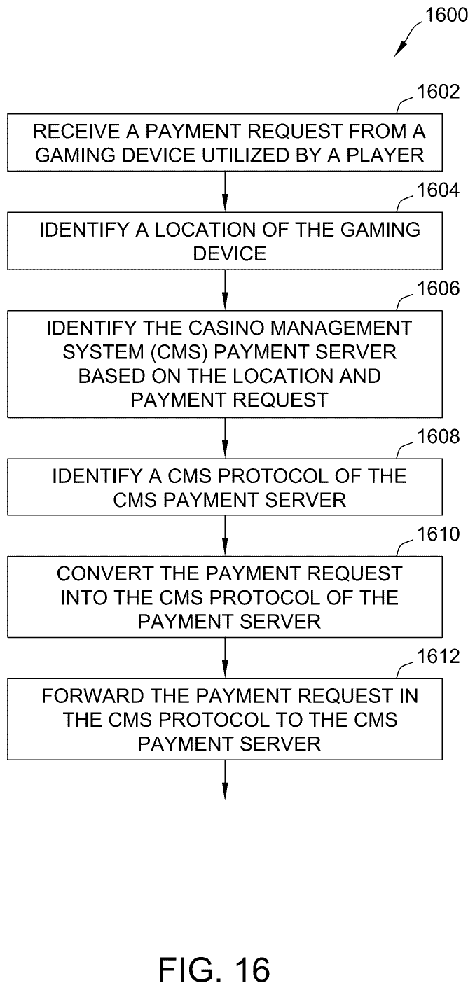

FIG. 16 depicts a flow chart of a method 1600 of mediating CMS communications between a plurality of incompatible CMS payment systems and a plurality of gaming devices of at least one gaming venue in an example embodiment. Method 1600 will be discussed with respect to system 400 of FIG. 4, although method 1600 may be performed by other systems, not shown in the Figures.

In this embodiment, method 1600 comprises receiving 1602, by central payments service 402, a payment request from a gaming device of the plurality of gaming devices utilized by a player. For example, EGM/T 406 and/or mobile game device 408 receives a payment request from a player, which is forwarded to central payments service 402. As discussed above, the payment request may comprise a credit request, a deposit request, and/or a cash out request from the player.

Method 1600 further comprises identifying 1604, by central payments service 402, a location of the gaming device. For example, in cases where the gaming device comprises EGM/Ts 406, which are generally at pre-defined locations within a casino, central payments service 402 may identify a location of EGM/Ts 406 using IDs or other indicia included within messages sent from EGM/Ts 406 to central payments service 402. In another example, in cases where the gaming device comprises mobile game devices 408, central payments service 402 may utilize location-based services implemented within the casino to identify the location of mobile game devices 408. For example, central payments service 402 may utilize beacons distributed throughout the casino, beacons 514 of uSMIBs 404, environmental sensors at locations around the casino, or other RF devices that broadcast IDs that are read by mobile game devices 408 and are forwarded to central payments service 402. Using broadcast IDs read and forwarded by mobile game devices 408 to central payments service 402, central payments service 402 is able to determine a location of mobile game device 408 within a casino.

Method 1600 further comprises identifying 1606, by central payments service 402, at least one CMS payment server of the plurality of incompatible CMS payment systems based on the location of the gaming device and the payment request. For example, central payments service 402 identifies one or more TITO servers 410 based on a location of EGM/Ts 406 and/or mobile game devices 408 and the payment request. As discussed above, payment requests may be directed to TITO servers 410 of the casino where the gaming device is located, and if a credit request or cash out request cannot be met at the casino where the player is currently playing, central payments service 402 may contact additional TITO servers 410 in order redeem credits at other casinos and purchase TITO vouchers for the player at the casino the player is at.

Method 1600 further comprises identifying 1608, by central payments service 402, at least one CMS protocol of the at least one CMS payment service. For example, central payments service 402 identifies the various CMS protocols in use by TITO servers 410 in order to implement the payment request from the player, as each of the different TITO servers 410 may utilize different CMS protocols.

Method 1600 further comprises converting 1610, by central payments service 402, the payment request into the at least one CMS protocol of the at least one CMS payment server, and forwarding 1612, by central payments service 402, the payment request in the at least one CMS protocol to the at least one CMS payment server. For example, central payments service 402 converts the payment request into one or more CMS protocols, depending on which TITO server 410 the request will be forwarded to, and forwards the payment request. As described above, the payment request may be handled by TITO servers 410 of the casino the player is currently at, and/or split up into multiple payment requests that are handled by TITO servers 410 not associated with the casino, in order to collate account balances at other casinos and implement the payment request for the player.

In some embodiments, the gaming device includes uSMIB 404. For example, EGM/Ts 406 may include uSMIB 404 as a hardware or software implementation, and/or mobile game devices 408 may include uSMIB 404 as a hardware or software implementation. In these embodiments, method 1600 may further include transmitting, to uSMIB 404 by central payments service 402, configuration data that configures uSMIB 404 to communicate with the gaming device and central payments service 402. For example, central payments service 402 retrieves configuration data from database 412 that varies depending on which EGM/Ts 406 and/or which mobile gaming devices 408 uSMIB 404 is associated with, and transmits the configuration data to uSMIBs 404. The configuration data may define how uSMIBs 404 communicate with central payments service 402, how uSMIBs 404 communicate with their respective EGM/Ts 406 and/or mobile game devices 408, routing information for the communications between EGM/Ts 406 and/or mobile game devices 408 and central payments service 402, etc. In some embodiments, central payments service 402 may be implemented in uSMIBs 404. For instance, the functionality described herein for central payments service 402 may be implemented by hardware and/or software implementations of uSMIB 404, operating in EGM/Ts 406 and/or mobile game devices 408.

In some embodiments, method 1600 further comprises identifying, by central payments service 402, a casino at the location of the gaming device, and identifying, by central payments service 402, the at least one CMS payment server based on the casino. For example, as described above, central payments service 402, when implementing a payment request from the player, may identify which casino the player is currently at, and utilize that casino's TITO server 410 in order to implement the payment request. As described above, if the payment request is a cash out or a credit request for the player, central payments service 402 may utilize the casino's TITO server 410 if the account balance of the player at that casino is sufficient to cover the payment request, and may contact other TITO servers 410 at other casinos in order to implement the request if the account balance of the player at the casino is insufficient. For example, if the player is at casino A and requests a credit request of $100, and the account balance of the player at casino A is less than $100, then central payments service 402 may contact TITO servers 410 associated with casino B and/or casino C in order to collate the player's account balances from casinos A and B in order to implement the credit request of $100.

Although the embodiments discussed used TITO voucher(s) as an exemplified value instrument, the processes for requesting credits, depositing credits, cashing out of a gaming device in a certain value instrument, is essentially the same for other value instruments such as cryptographic currencies, NFTs, loyalty points, virtual goods, and the like. Note that some value instruments require the sell or buy of value instruments owned by the user (e.g., virtual goods, cash, TITO vouchers, etc.) on an Exchange or a Marketplace appropriate for the value instrument involved in the transaction in exchange for gaming credits at a given time and/or location.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A system configured to implement ticket in ticket out (TITO) voucher exchanges between a plurality of casinos for a player, the system comprising:
a central payments service implemented by at least one processor that is configured to execute programmed instructions which, when executed by the at least one processor, cause the at least one processor to:
receive a withdrawal request from the player to withdraw an amount of funds at a first casino of the plurality of casinos;
identify a first player account of the player at the first casino, the first player account having at least one first TITO voucher, the first casino having a first TITO server;
determine that the amount of the withdrawal request exceeds a balance of the at least one first TITO voucher;
identify a second player account of the player at a second casino of the plurality of casinos, the second player account having at least one second TITO voucher, the second casino having a second TITO server;
select and redeem, from the second player account using the second TITO server, the at least one second TITO voucher to generate proceeds for the withdrawal request;
purchase, using the first TITO server and the proceeds, at least one third TITO voucher;
provide the at least one third TITO voucher to the player; and
record, in a central ledger, one or more TITO transactions at the first TITO server and the second TITO server used to process the withdrawal request for the player.

2. The system of claim 1, wherein the at least one processor is configured to:
link, using a master TITO ticket, the at least one first TITO voucher at the first player account and the at least one second TITO voucher at the second player account; and
select and redeem, using the master TITO ticket, the at least one second TITO voucher to generate the proceeds for the withdrawal request.

3. The system of claim 1, wherein the at least one processor is configured to:
store, in the central ledger, an aggregate balance for the player comprising the at least one first TITO voucher for the player at the first player account and the at least one second TITO voucher for the player at the second player account; and
determine that the amount of the withdrawal request exceeds the balance of the at least one first TITO voucher using the aggregate balance for the player.

4. The system of claim 1, wherein the at least one processor is further configured to:
determine that the at least one at the second TITO voucher is nearing an expiration date; and
in response to determining that the at least one second TITO voucher is nearing the expiration date, to:
select and redeem, from the second player account using the second TITO server, the at least one second TITO voucher to generate net proceeds; and
purchase, using the net proceeds and the second TITO server, at least one fourth TITO voucher for the second player account of the player.

5. The system of claim 1, wherein the at least one processor is further configured to:
identify a gaming device utilized by the player for a gaming session at the gaming device; and
provide the at least one third TITO voucher to the gaming device to fund the gaming session.

6. The system of claim 5, wherein the at least one processor is further configured to:
identify a location of the gaming device; and
identify the first casino and the first TITO server based on the location of the gaming device.

7. The system of claim 5, wherein:
the system further comprises:
a universal slot machine interface board (uSMIB) disposed within and configured to communicate with the gaming device, and
the uSMIB is configured to implement the central payments service.

8. The system of claim 5, wherein:
the gaming device comprises a mobile gaming device.

9. A method of implementing ticket in ticket out (TITO) voucher exchanges between a plurality of casinos for a player, the method comprising:
receiving, by a central payments service, a withdrawal request from the player to withdraw an amount of funds at a first casino of the plurality of casinos;
identifying, by the central payments service, a first player account of the player at the first casino, the first player account having at least one first TITO voucher, the first casino having a first TITO server;
determining, by the central payments service, that the amount of the withdrawal request exceeds a balance of the at least one first TITO voucher;
identifying, by the central payments service, a second player account of the player at a second casino of the plurality of casinos, the second player account having at least one second TITO voucher, the second casino having a second TITO server;
selecting and redeeming, by the central payments service from the second player account using the second TITO server, the at least one second TITO voucher to generate proceeds for the withdrawal request;
purchasing, by the central payments service using the first TITO server and the proceeds, at least one third TITO voucher;
providing, by the central payments service, the at least one third TITO voucher to the player; and
recording, by the central payments service in a central ledger, one or more TITO transactions at the first TITO server and the second TITO server used to process the withdrawal request for the player.

10. The method of claim 9, further comprising:
linking, by the central payments service using a master TITO ticket, the at least one first TITO voucher at the first player account and the at least one second TITO voucher at the second player account; and
selecting and redeeming, by the central payments service using the master TITO ticket, the at least one second TITO voucher to generate the proceeds for the withdrawal request.

11. The method of claim 9, further comprising:
storing, by the central payments service in the central ledger, an aggregate balance for the player comprising the at least one first TITO voucher for the player at the first player account and the at least one second TITO voucher for the player at the second player account; and
determining, by the central payments service, that the amount of the withdrawal request exceeds the balance of the at least one first TITO voucher using the aggregate balance for the player.

12. The method of claim 9, further comprising:
determining, by the central payments service, that the at least one at the second TITO voucher is nearing an expiration date; and
in response to determining that the at least one second TITO voucher is nearing the expiration date:
selecting and redeeming, by the central payments service from the second player account using the second TITO server, the at least one second TITO voucher to generate net proceeds; and
purchasing, by the central payments service using the net proceeds and the second TITO server, at least one fourth TITO voucher for the second player account of the player.

13. The method of claim 9, further comprising:
identifying, by the central payments service, a gaming device utilized by the player for a gaming session at the gaming device; and
providing, by the central payments service, the at least one third TITO voucher to the gaming device to fund the gaming session.

14. The method of claim 13, further comprising:
identifying, by the central payments service, a location of the gaming device; and
identifying, by the central payments service, the first casino and the first TITO server based on the location of the gaming device.

15. The method of claim 13, further comprising:
installing a universal slot machine interface board (uSMIB) within and in communication with the gaming device,
wherein the uSMIB is configured to implement the central payments service.

16. The method of claim 13, wherein:
the gaming device comprises a mobile gaming device.

17. A system configured to implement ticket in ticket out (TITO) voucher exchanges between a plurality of casinos for a player, the system comprising:
a central payments service implemented by at least one processor that is configured to execute programmed instructions which, when executed by the at least one processor, cause the at least one processor to:
receive a deposit request from the player to deposit an amount of funds;
identify a location of the player;
identify a casino of the plurality of casinos based on the location of the player;
purchase, in the amount of the funds using a TITO server of the casino, at least one TITO voucher;
provide the at least one TITO voucher to the player; and
record, in a central ledger, one or more TITO transactions at the TITO server used to process the deposit request for the player.

18. The system of claim 17, wherein the at least one processor is further configured to:
identify a gaming device utilized by the player for a gaming session at the gaming device; and
provide the at least one TITO voucher to the gaming device to fund the gaming session.

19. The system of claim 18, wherein the at least one processor is further configured to:
identify a location of the gaming device; and
identify the location of the player based on the location of the gaming device.

20. The system of claim 18, wherein:
the system further comprises:
a universal slot machine interface board (uSMIB) disposed within and configured to communicate with the gaming device, and
the uSMIB is configured to implement the central payments service.
